(19) United States
(12) Patent Application Publication
(10) Pub. No.: US 2013/0166615 A1
(43) Pub. Date: Jun. 27, 2013

(54) CONTINUUM MOTION ANALYSIS METHOD, AND CONTINUUM MOTION ANALYSIS APPARATUS

(71) Applicant: FUJITSU LIMITED, Kawasaki-shi (JP)

(72) Inventor: Tamon SUWA, Kawasaki (JP)

(73) Assignee: FUJITSU LIMITED, Kawasaki-shi (JP)

(21) Appl. No.: 13/772,871

(22) Filed: Feb. 21, 2013

Related U.S. Application Data
(63) Continuation of application No. PCT/JP2010/064290, filed on Aug. 24, 2010.

(51) Int. Cl. G06F 17/10

(52) U.S. Cl. CPC G06F 17/10
USPC 708/200

(57) ABSTRACT

A computer-readable recording medium has stored therein a communication-path control program causing a computer to execute a process which includes receiving input of data including information of an influence range representing each of continuum particles when the continuum is represented as a particle, and data representing each micro-surface component, which includes information of a normal direction when a fixed boundary is represented as a set of minute regions; calculating a repulsive force of a normal direction of the micro-surface component, which acts on the continuum particle from each of the micro-surface components intersected with the influence range of the continuum particle; calculating a force from the fixed boundary acting on each of the continuum particles by adding the repulsive forces acting on each of the continuum particles from each of the micro-surface components; and analyzing the motion of the continuum, based on the force from the fixed boundary.

### CROSS-REFERENCE TO RELATED APPLICATION

This application is a continuation of International Application No. PCT/JP2010/064290, filed on Aug. 24, 2010, the entire contents of which are incorporated herein by reference.

### FIELD

The embodiments discussed herein are directed to a continuum motion analysis method, and a continuum motion analysis apparatus.

### BACKGROUND

A technology called a particle method has been proposed in fluid analysis that uses numerical calculation to analyze the flow of water or air, or in elastic body analysis such as analysis of that the behavior of a compressed rubber. Specifically, the particle method is a technique to analyze the motion of a continuum as the motion of a finite number of particles. Examples of currently-proposed typical particle methods include a SPH (Smoothed Particles Hydrodynamics) method and an MPS (Moving Particles Semi-implicit) method. Examples of the particle method also include a method called a discrete element method that is a technique to analyze the behavior of powder and granular material by representing the powder and granular material as a particle group.

In the past, in the particle method, the following methods have been proposed as methods for representing a fixed boundary when representing an analysis target by using particle distribution.

First, the following three technologies have been proposed as the standard technologies for the particle method. In the first method, virtual fluid particles (hereinafter, referred to as “boundary particles”) are disposed along a boundary. There has been proposed a technology for representing a fixed boundary by regarding boundary particles as fluid adhered fixedly to the fixed boundary and giving a force acting between the particles representing a continuum and the boundary particles as a force acting in fluid analysis. In the second method, boundary particles are disposed in the same way as in the first method. There has been proposed a technology for representing a continuum by setting a repulsive force that has a magnitude according to a function based on the distance between the respective particles and acts on each particle from a fixed boundary in the direction along a relative position vector of each particle. In this technology, analysis can be performed by restricting the motion of particles representing a continuum within an inner region of a fixed boundary. In the third method, there has been proposed a technology for representing a fixed boundary by disposing virtual continuum particles at positions that are reflectively symmetrical to particles representing a continuum to be analyzed, with respect to a predefined boundary surface.

Also, as another method, first, boundary particles and continuum particles are respectively regarded as having a smooth closed surface that is not necessarily a spherical surface. There has been proposed a technology for representing a fixed boundary by making an appropriate reduction when the closed surfaces have an overlap, and calculating a repulsive force acting on each particle from the fixed boundary, based on the distance and direction from the center of each particle to the contact point when the closed surfaces contact each other at one point.

Also, as another method, first, boundary particles are disposed. In the continuum particles approaching the boundary particles within a predetermined distance, the distance of a vertical line drawn from the continuum particle and the distance between the continuum particle and the boundary particle on a boundary surface are calculated. There has been proposed a technology for representing a fixed boundary by giving a magnitude by a function of the respective distances calculated and giving the continuum particle a repulsive force that acts on each particle from the fixed boundary in the direction along a vertical line of the boundary surface.

In addition, as another method, first, a fixed boundary is represented as a set of polygons. There has been proposed a technology for giving a repulsive force between a continuum particle and a polygon having the nearest central coordinates, wherein the repulsive force is represented by a function of the distance from the continuum particle and a plane surface including the polygon. In this technology, only when the distance from the continuum particle and the plane surface including the polygon is equal to or smaller than a predetermined value ε, the repulsive force is set to act on the continuum particle from the plane surface.
Patent Document 1: Japanese Laid-open Patent Publication No. 2009-026279
Non Patent Document 1: G. R. Liu, M. B. Liu, Smoothed Particle Hydrodynamics: A Meshfree Particle Method, World Scientific Pub Co Inc. 2003. p. 138-141, 4.4.8. Boundary treatment
Non Patent Document 2: M. G. Gesteira, B. D. Rogers, R. A. Dalrymplem, A. J. C. Crespo, M. Narayanaswamy, User Guide for the SPHysics Code v1.4, p. 16-19, 2.4, Boundary conditions (clause 2.4.3 is excluded)
Non Patent Document 3: HARADA Takahiro, KOSHIZUKA Seiichi, KAWAGUCHI Yoichiro, “Real-time Ductile Simulation of Fluid and Texture” Research Report of Information Processing Society of Japan, Report of Graphics and CAD Research Society, 2007/11/12(full text)

However, in the prior art that represents a fixed boundary by a force acting from a boundary particle in a general fluid analysis, it is necessary to use a plurality of particles in order to represent a fixed boundary having a smooth shape. Therefore, in a calculator that performs analysis, a lot of memory usage and calculation time are required. The same is true of any of the prior art that sets a repulsive force from a fixed boundary in a direction based on a relative position vector between particles, and a technique that arranges a virtual continuum particle at a position reflectively symmetric to a boundary surface.

Also, in the technique that arranges the virtual continuum particle at the position reflectively symmetric to the boundary surface, it is necessary to analytically represent the boundary surface so as to calculate the reflective symmetric position. Therefore, there is a problem that the technique cannot be applied to a boundary shape in which the formula representing a normal direction is not specially given or is difficult to give.

Also, in the prior art that sets an arbitrary smooth closed surface to both of the continuum particle and the boundary particle, a lot of data and calculation amount are required for each pair of the continuum particle and the boundary particle so as to calculate a repulsive force from the fixed boundary. Therefore, this technique also has required a lot of memory usage and calculation time.

In contrast, in the prior art that sets the repulsive force of the normal direction as the force from the fixed boundary, the memory usage or the like can be reduced. However, this prior art obtains four neighbor particles (i−1, i+1, j−1, j+1) located at positions shifted in a direction of an x-coordinate from a certain boundary particle i by one in a positive or negative direction and shifted in a direction of a y-coordinate by one in a positive or negative direction. Then, a normal vector is calculated by an outer product of a vector directed from i−1 to i+1 and a vector directed from j−1 to j+1 That is, in this prior art, a particle distribution on a boundary surface needs to be arranged at regular grid points or coordinate positions obtained by continuously deforming them. Therefore, there has been a problem in that it is impossible to apply to a case where boundary particles are arranged at the central positions of tetra meshes, or the like.

Also, in the prior art that gives a repulsive force between polygons whose central coordinates are the nearest, when the size of another polygon is used because the size of the polygon is not constant, the non-uniform size of the polygon may cause an unreasonable repulsive force near the boundary of the polygon. Therefore, the size of the polygon needs to be constant for application. Therefore, this prior art also has a problem that it cannot be applied.

### SUMMARY

According to an aspect of an embodiment, a computer-readable recording medium has stored therein a continuum motion analysis program causing a computer to execute a process including; receiving input of data including information of an influence range representing each of continuum particles when the continuum is represented as a particle, and data representing each micro-surface component, which includes information of a normal direction when a fixed boundary is represented as a set of minute regions; first calculating a repulsive force of the normal direction of each of the micro-surface components, which acts on the continuum particle from each of the micro-surface components intersected with the influence range of the continuum particle; second calculating a force from the fixed boundary acting on each of the continuum particles by adding the repulsive forces acting on each of the continuum particles from each of the micro-surface components; and analyzing the motion of the continuum, based on the force acting on each of the continuums from the fixed boundary.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of a continuum motion analysis apparatus according to an embodiment.

FIG. 2 is a flowchart of processing of analyzing a motion of a continuum by a continuum motion analysis program according to an embodiment.

FIG. 3 is a diagram for describing a component of a normal direction and a component of a direction perpendicular to the normal direction in a micro-surface component in a relative position vector of a continuum particle and a micro-surface component.

FIG. 4 is a diagram for describing a determination as to whether an influence range of a continuum particle and a micro-surface component are intersected with each other.

FIG. 5 is a diagram for describing an area of an intersection between a continuum particle and a micro-surface component.

FIG. 6 is a diagram for describing a list of micro-surface components contacting a continuum particle.

FIG. 7 is a diagram of a micro-surface component intersected as if protruding in a direction of a continuum particle.

FIG. 8 is a flowchart of processing of identifying a nearest micro-surface component.

FIG. 9 is a diagram for describing a determination as to whether two micro-surface components are intersected with each other, as if protruding in a direction of a continuum particle.

FIG. 10 is a flowchart of processing of determining whether two micro-surface components are intersected with each other.

FIG. 11 is a diagram of a state in which a plane including a micro-surface component of one side is intersected with a micro-surface component of the other side.

FIG. 12 is a diagram illustrating a computer that executes a continuum motion analysis program.

### DESCRIPTION OF EMBODIMENT

Preferred embodiments of the present invention will be explained with reference to accompanying drawings. Also, the continuum motion analysis method, and the continuum analysis apparatus discussed therein are not limited by the following embodiments.

Herein, a case of analyzing a continuum motion with respect to a fixed boundary, like the injection of water into a cup or the flow of water from a dam, will be described. Also, hereinafter, when a continuum to be analyzed is represented by a particle, the particle is referred to as a “continuum particle”. Also, when a fixed boundary is represented by a set of minute surfaces, the minute surfaces are referred to as “micro-surface components”. In other words, the continuum particle is defined by modeling a continuum by a particle. Also, in other words, the micro-surface component is defined by modeling a surface component obtained by dividing a fixed boundary, such as a wall of a container storing a fluid, into minute portions. The micro-surface component has an arbitrary shape. That is, the micro-surface component may not be fixed to a specific shape and may have a free shape. Specifically, the micro-surface component may be represented by a minute disk arranged to cover the fixed boundary, or may also be represented by a polygon arranged to cover the fixed boundary. Furthermore, in order to analyze the motion of the continuum, it is necessary to obtain the motion of the continuum in a predetermined certain time. For this purpose, the motions of the continuum at a certain time point within a certain time are obtained, and they are integrated as a series of motions.

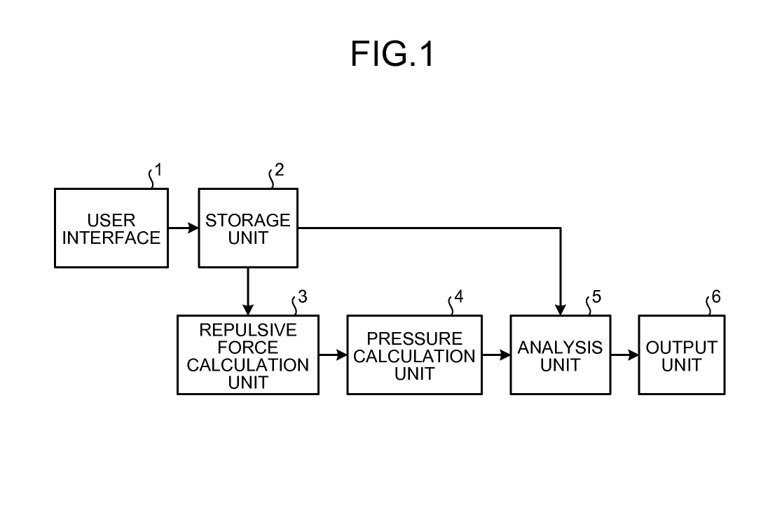

FIG. 1 is a block diagram of a continuum motion analysis apparatus according to an embodiment. As illustrated in FIG. 1, the continuum motion analysis apparatus according to the embodiment includes a user interface 1, a storage unit 2, a repulsive force calculation unit 3, a pressure calculation unit 4, an analysis unit 5, and an output unit 6.

The user interface 1 includes an input device such as a keyboard or a mouse, and a display device such as a monitor. An operator uses the user interface 1 to input data used for analyzing the motion of the continuum, and checks an analysis result displayed on the display device.

Herein, the data used for analyzing the motion of the continuum is continuum particle information representing a physical model set to the continuum particle and each continuum particle, and micro-surface component information representing each micro-surface component. Herein, the physical model is a model for representing a physical representation of the motion of the continuum. Examples of the physical model set to the continuum particle include a physical model in a case where a fluid is modeled. The continuum particle information is, for example, central coordinates, a velocity, an influence radius, a density, a mass, a deformation gradient tensor, a material property, and a temperature. A sphere with the center of the continuum particle as the center and with the influence radius as the radius represents a range in which the continuum particle influences another particle, such as applying a pressure, and a pressure is applied from another particle against the continuum particle. That is, a particle located outside the sphere with the center of the continuum particle as the center and with the influence radius as the radius does not influence a continuum particle located at the center of the sphere. Also, in a case where the micro-surface component is a disk, the micro-surface component information is, for example, central coordinates, a normal vector representing a normal direction of the micro-surface component, and an area. Herein, the normal direction represents a normal direction of a micro-surface component that is directed from the fixed boundary toward a side where the continuum exists. Also, in a case where the micro-surface component is a polygon, the micro-surface component information is, for example, vertex coordinates of each micro-surface component. Herein, in the case where the micro-surface component is a polygon, if the vertex coordinates of each micro-surface component are given, the area and the normal direction thereof can be calculated. That is, in the case where the micro-surface component is the polygon, giving the vertex coordinates of each micro-surface component is the same as giving the area and the normal direction of the micro-surface component.

The storage unit 2 is a storage device such as a hard disk. The storage unit 2 stores the continuum particle information and the micro-surface component information that are input from the user interface 1.

The repulsive force calculation unit 3 extracts the micro-surface component existing within the influence range of the continuum particle. The repulsive force calculation unit 3 calculates a force applied to the continuum particle directed toward the normal direction of the micro-surface component from each extracted micro-surface component, and calculates a repulsive force caused by each micro-surface component by performing weighting according to an area of a portion where the continuum particle and the influence range of the micro-surface component are intersected with each other. The calculation of the repulsive force will be described below in detail.

The pressure calculation unit 4 adds the repulsive force calculated by the repulsive force calculation unit 3 for each continuum particle, and calculates a pressure from the fixed boundary with respect to each continuum particle.

The analysis unit 5 calculates acceleration based on the physical model of each continuum particle at a certain time point. Also, the analysis unit 5 calculates acceleration caused by the pressure that is applied from the fixed boundary to each continuum particle. The analysis unit 5 calculates the acceleration of the continuum particle by adding the acceleration caused by the pressure from the fixed boundary to the acceleration based on the physical model of the continuum particle.

Then, the analysis unit 5 performs time integration on the physical quantity of the continuum particle by using a time derivative term containing the calculated acceleration, and obtains the motion of the continuum particle at a certain time point. The analysis unit 5 performs the motion of the continuum particle at this certain time point with respect to each successive time point, and analyzes the motion of the continuum.

The output unit 6 outputs an analysis result obtained by the analysis unit 5. For example, the output unit 6 outputs the analysis result to the storage device as a file, or displays the analysis result on the display device as a figure, or outputs the analysis result by printing on a paper using a printer.

As described above, first, the repulsive force of the normal direction from the micro-surface component, which becomes near to the influence range of the continuum particle, is calculated by the repulsive force calculation unit 3. Then, the pressure against the continuum particle from the micro-surface component, which becomes near to the influence range of the continuum particle, is calculated by the pressure calculation unit 4. Then, the acceleration is calculated from the pressure against the continuum particle by the analysis unit 5. Therefore, the acceleration of the normal direction of the micro-surface component may be applied to the continuum particle, to which the micro-surface component becomes near within the influence range, and the fixed boundary condition representing the action from the fixed boundary with respect to the continuum particle may be applied to the motion of the continuum. Next, specific processing of analyzing the motion of the continuum by applying the fixed boundary condition to the continuum will be described in detail.

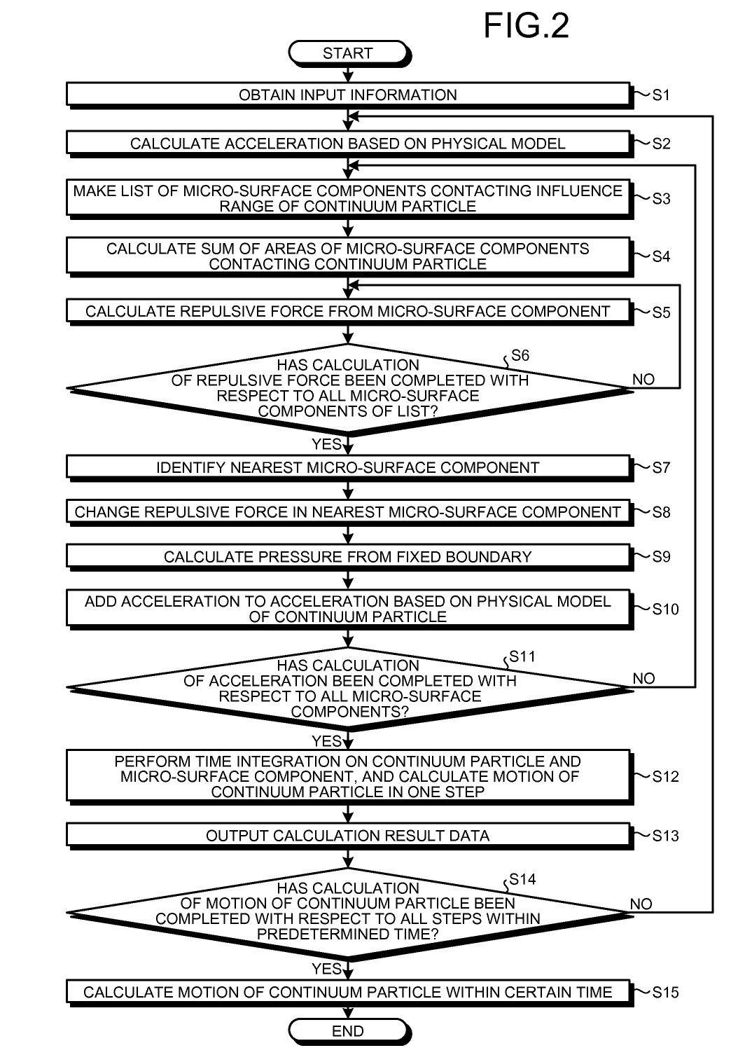

First, the flow of processing of analyzing the motion of the continuum by a continuum motion analysis program according to an embodiment will be described. FIG. 2 is a flowchart of the processing of analyzing the motion of the continuum by the continuum motion analysis program according to the embodiment.

The storage unit 2 obtains and stores continuum particle information and micro-surface component information that are input from the user interface 1 (step S1).

The analysis unit 5 calculates the acceleration of each continuum particle, based on the physical model, by analyzing the motion of the continuum particle according to the physical model set to the input continuum particle (step S2). In this case, the analysis unit 5 performs the analysis by using a general motion equation for performing motion analysis. For example, the analysis unit 5 determines acceleration by solving the Navier-Stokes equation, with respect to the continuum particle that is a modeling of a fluid. The Navier-Stokes equation is an equation that is expressed as Formula (1) below in a case of the incompressible flow.

$$\frac{\partial v}{\partial t} + ( v \cdot ∇ ) v = - \frac{1}{ρ} ∇ p + v {∇}^{2} v + F \\ ∇ = ( \frac{\partial }{\partial x} , \frac{\partial }{\partial y} , \frac{\partial }{\partial z} ) \qquad ( 1 )$$

Herein, v is a velocity, F is an external force per unit mass, ρ is a density, p is a pressure, and ν is a kinematic viscosity coefficient.

Specifically, the analysis unit 5 performs the analysis by numerically solving the simultaneous equations of the Navier-Stokes equation and the continuity equation derived from the mass conservation law, and furthermore, if necessary, the state equation.

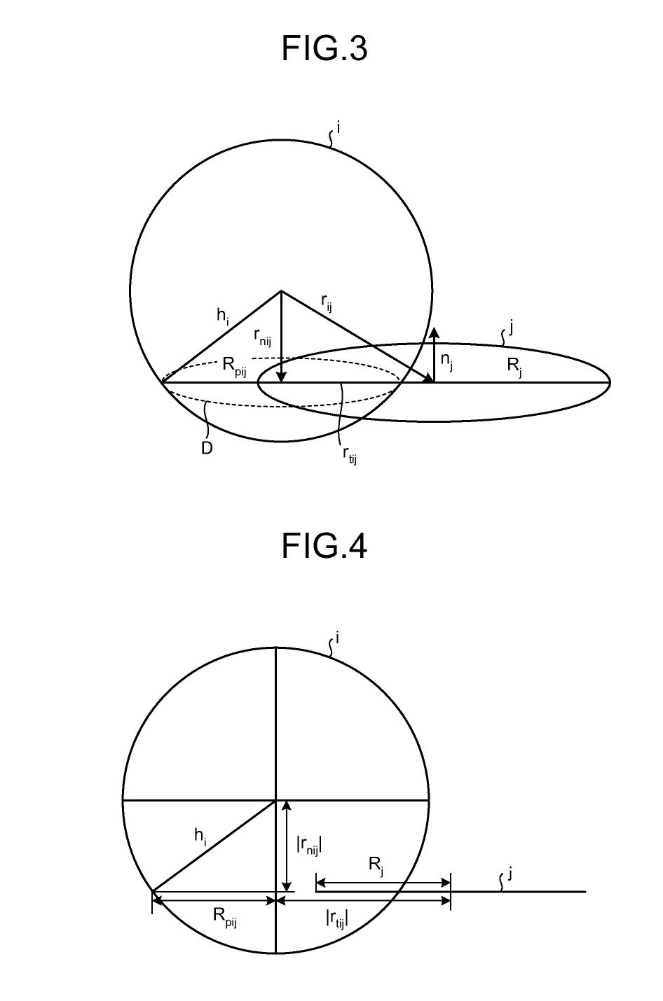

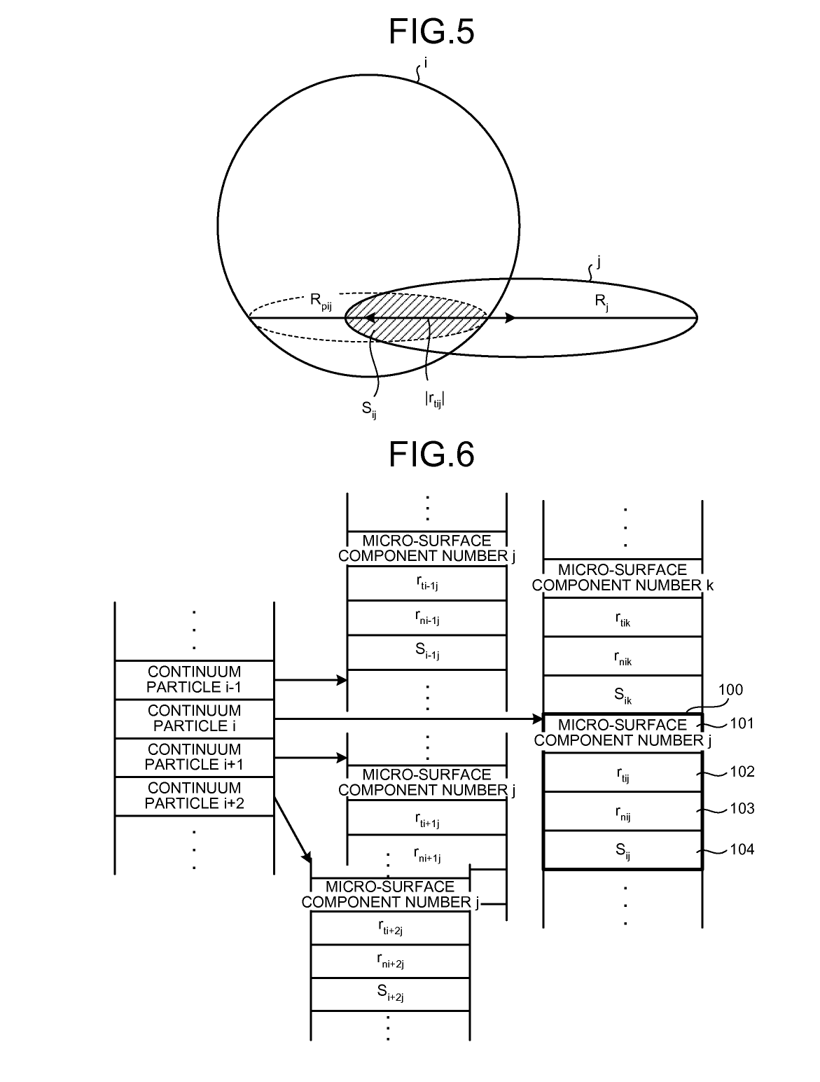

Subsequently, the repulsive force calculation unit 3 makes a list of micro-surface components existing within the influence range of each continuum particle (step S3). Herein, making the list of micro-surface components existing within the influence range of the continuum particle by the repulsive force calculation unit 3 will be described in detail with reference to FIGS. 3 to 6. FIG. 3 is a diagram for describing the component of the normal direction and the component of the direction perpendicular to the normal direction in the micro-surface component in the relative position vector of the continuum particle and the micro-surface component. FIG. 4 is a diagram for describing the determination as to whether the influence range of the continuum particle and the micro-surface component are intersected with each other. Also, FIG. 5 is a diagram for describing the area of the intersection between the continuum particle and the micro-surface component. Also, FIG. 6 is a diagram for describing the list of micro-surface components contacting the continuum particle.

In the following description, numbers are assigned to all continuum particles, and an arbitrary continuum particle number is assumed as i. Also, numbers are assigned to all micro-surface components, and an arbitrary micro-surface component number is assumed as j. The continuum particle of the number i is represented as the continuum particle i, and the micro-surface component of the number j is represented as the micro-surface component j. Furthermore, as illustrated in FIG. 3, the relative position vector of the continuum particle i and the micro-surface component j is assumed as rᵢⱼ. Herein, the relative position vector of the continuum particle i and the micro-surface component j is a vector that is directed from the center of the continuum particle i toward the center of the micro-surface component j. Also, the influence radius of the continuum particle i is assumed as hᵢ. Furthermore, the area of the micro-surface component j is assumed as Aⱼ. In FIG. 3, for ease of understanding, symbol i is assigned to the influence range of the continuum particle, but i represents the continuum particle.

The repulsive force calculation unit 3 calculates the component rₙᵢⱼ of the nⱼ direction of rᵢⱼ illustrated in FIG. 4 as rₙᵢⱼ=(rᵢⱼ·nⱼ)nⱼ. Also, the repulsive force calculation unit 3 calculates the component rₜᵢⱼ perpendicular to nⱼ of rᵢⱼ illustrated in FIG. 4 as rₜᵢⱼ=rᵢⱼ−rₙᵢⱼ. Also, the repulsive force calculation unit 3 calculates the radius Rⱼ of the micro-surface component illustrated in FIG. 4 as Rⱼ=(Aⱼ/π)^{1/2}.

Herein, if |rₙᵢⱼ|<hᵢ, the disk D is constituted when the plane including the micro-surface component j and the influence range of the continuum particle i are intersected with each other. The radius Rₚᵢⱼ of the disk D is represented as Rₚᵢⱼ=(hᵢ²−rₙᵢⱼ²)^{1/2}.

As illustrated in FIG. 4, when the influence range of the continuum particle i and the micro-surface component j are intersected with each other, the length of rₜᵢⱼ is shorter than the added length of Rⱼ and Rₚᵢⱼ. That is, when the condition of |rₙᵢⱼ|<hᵢ or Rⱼ+Rₚᵢⱼ>|rₜᵢⱼ| is satisfied, the repulsive force calculation unit 3 determines that the micro-surface component j is intersected with the influence range of the continuum particle i, in other words, the micro-surface component j is within the influence range of the continuum particle i.

The repulsive force calculation unit 3 extracts the micro-surface component j intersected with the influence range of each continuum particle i by performing the determination as to whether the micro-surface component j is intersected with the influence range of the continuum particle i, with respect to a set of all micro-surface components j and continuum particles i.

Furthermore, the repulsive force calculation unit 3 calculates the area Sᵢⱼ of the intersected portion when the influence range of the continuum particle i and the micro-surface component j illustrated in FIG. 5 are intersected with each other. Specifically, the repulsive force calculation unit 3 calculates the area Sᵢⱼ as the area of the intersection between the circle with the radius Rⱼ and the circle with the radius Rₚᵢⱼ, the centers of which are spaced apart from each other by |rₜᵢⱼ|.

With respect to each continuum particle i, the repulsive force calculation unit 3 makes a list of the number representing the micro-surface component j intersected with the influence range of the continuum particle i, the normal component of the relative position vector, the component perpendicular to the normal line, and the area of the portion where the influence range of the continuum particle i and the micro-surface component j are intersected with each other. This list is conceptually represented in FIG. 6. As illustrated in FIG. 6, the list is made for each continuum particle. For example, FIG. 6 illustrates a list for the continuum particles i−1, i, i+1 and i+2. In the list, a group 100 enclosed by a frame is described as a group of one micro-surface component. In the group 100, the number representing the micro-surface component is described in a field 101, the normal component of the relative position vector is described in a field 102, the component perpendicular to the normal line of the relative position vector is described in a field 103, and the area of the portion where the influence range of the continuum particle and the micro-surface component are intersected with each other is described in a field 104. For example, in a case where the micro-surface component j is intersected with the influence range of the continuum particle i, the micro-surface component number j is described in the field 101 of the group 100, rₜᵢⱼ is described in the field 102, rₙᵢⱼ is described in the field 103, and Sᵢⱼ is described in the field 104. Also, like the list for the continuum particle i of FIG. 6, the group 100 corresponding to the micro-surface component is created for each micro-surface component in a manner that the micro-surface component number is assumed as k and the micro-surface component number is assumed as j. Also, in FIG. 6, it can be known that since the micro-surface component number j is included in the list for the continuum particles i−1, i, i+1, and i+2, the micro-surface component number j is also within the influence range with respect to those continuum particles i−1, i, i+1, and i+2.

After completing the list, the repulsive force calculation unit 3 calculates the sum of the areas of the intersections between the micro-surface components j and the influence range of the continuum particles i existing in the list (step S4). For example, when the continuum particle is the continuum particle i, the sum of the areas of the intersections between the micro-surface components and the influence range of the continuum particles is represented as S_{total,i}.

Subsequently, the repulsive force calculation unit 3 calculates the repulsive force acting from each micro-surface component to each continuum particle (step S5). Hereinafter, the calculation of the repulsive force by the repulsive force calculation unit 3 will be described in detail. Herein, the repulsive force acting from the micro-surface component j to the continuum particle i will be described as an example.

The repulsive force calculation unit 3 previously stores the equation of calculating the repulsive force that acts as a distance |rₙᵢⱼ| between the continuum particle i and the micro-surface component j according to the normal line of the micro-surface component j is nearer to a predetermined distance r_{cutoff}; is increased as the distance |rₙᵢⱼ| is shorter; and does not diverge in the limit where |rₙᵢⱼ| becomes zero. For example, in the embodiment, the repulsive force calculation unit 3 stores Formula (2) below.

$${f}_{ij} = {f}_{0 , i} {n}_{j} ( {s}_{ij} / {S}_{total , i} ) \{ \begin{matrix}\frac{1 - {q}_{f max}}{{q}_{f max}} & \vert {r}_{nij} \vert < {r}_{f max} \\ \frac{1 - q}{q} & {r}_{f max} < \vert {r}_{nij} \vert < {r}_{cutoff} \\ 0 & {r}_{cutoff} < \vert {r}_{nij} \vert\end{matrix} \qquad ( 2 )$$

Herein, r_{fmax} is a value determined as the limit value of the distance that can take a value at which the repulsive force increases in inverse proportion to the distance, and is a fixed value close to zero. That is, when the distance between the continuum particle i and the micro-surface component j is closer than r_{fmax}, the repulsive force becomes constant. r_{fmax} is a value close to zero, and may take an arbitrary value. However, when r_{fmax} becomes too large, a sufficient repulsive force cannot be obtained. On the contrary, when r_{fmax} becomes too small, the repulsive force becomes too large and thus the numerical calculation becomes unstable. Therefore, it is preferable that r_{fmax} be set considering the repulsive force required in the analysis of the continuum and the stability of the numerical calculation. Statistically, when r_{fmax} is smaller than 1/100 of r_{cutoff}, the numerical calculation becomes unstable. Also, statistically, when r_{fmax} is larger than 1/10 of r_{cutoff}, a sufficient repulsive force cannot be obtained and the fixed boundary becomes unclear. Therefore, in the embodiment, r_{fmax} is set to 1/10 to 1/100 of r_{cutoff}. This r_{fmax} corresponds to an example of the predetermined distance. Also, q=|rₙᵢⱼ|/r_{cutoff}, q_{fmax}=r_{fmax}/r_{cutoff}. That is, q is a value representing a distance normalized by r_{cutoff}. q_{fmax} is a value normalized by r_{fmax}, which is the limit value of the distance that can take a value at which the repulsive force increases in inverse proportion to the distance. Also, f_{0,i} is the magnitude of the repulsive force that is the reference. There is no limitation to f_{0,i} as long as f_{0,i} is a large value. For example, in the embodiment, f_{0,i}=mᵢ×c_{x,i}²/hi (mᵢ is the mass of the continuum particle i, and c_{x,i} is the sound speed).

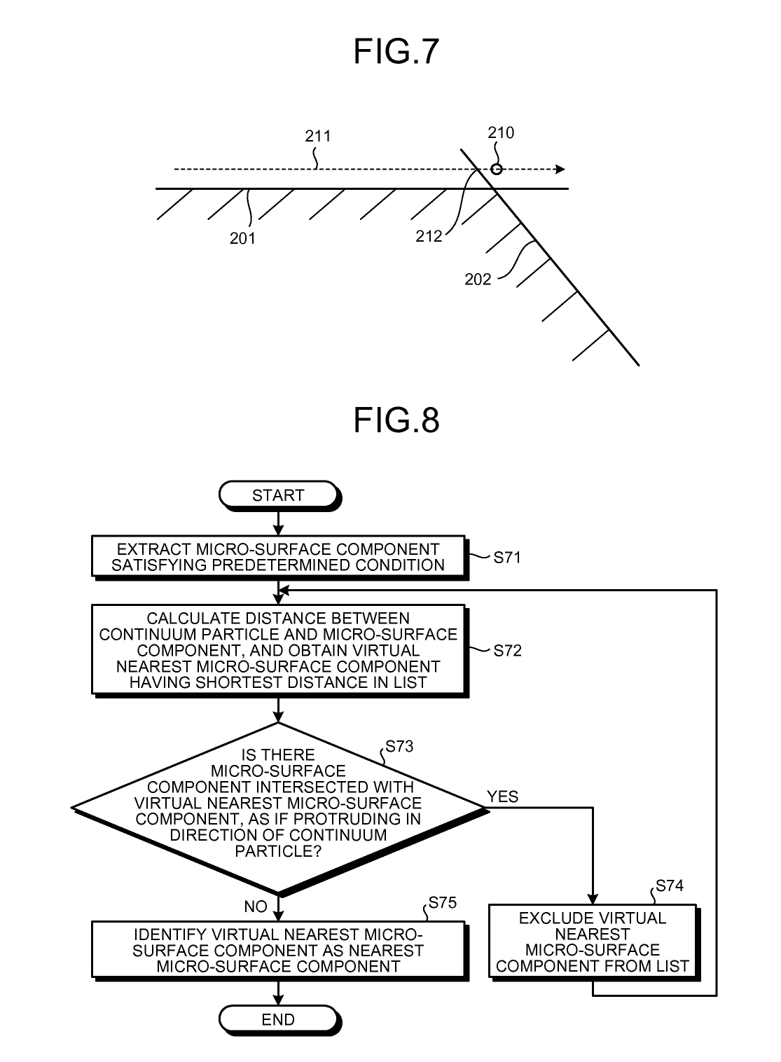

In Formula (2), when |rₙᵢⱼ|<r_{fmax}, the last term is (1−q_{fmax})/q_{fmax}. Herein, since q_{fmax} is a fixed value, (1−q_{fmax})/q_{fmax} is also a fixed value. That is, when |rₙᵢⱼ|<r_{fmax}, even though rₙᵢⱼ becomes short, the value does not increase. Even though rₙᵢⱼ becomes zero, the value of the repulsive force does not diverge. Herein, the reason why Formula (2) is configured not to diverge even though rₙᵢⱼ becomes zero will be described with reference to FIG. 7. FIG. 7 is a diagram of the micro-surface component intersected as if protruding in the direction of the continuum particle.

A portion indicated by hatched lines of FIG. 7 is a region that is a side opposite to the continuum with respect to the fixed boundary. In FIG. 7, as if the surface formed by the micro-surface component 201 and the micro-surface component 202 protrudes in the direction of the continuum particle, the micro-surface component 201 and the micro-surface component 202 are intersected with each other. Hereinafter, the case where a single continuum particle 210 moves along an arrow 211 will be described.

The repulsive force acting from the micro-surface component 201 and the micro-surface component 202 to the continuum particle 210 acts in the normal direction facing opposite to the region indicated by hatched lines. When the continuum particle 210 moves as indicated by the arrow 211, until the continuum particle 210 gets over an intersection point 212 between the micro-surface component 202 and the arrow 211, no repulsive force from the micro-surface component 202 act on the continuum particle 210 and only the repulsive force from the micro-surface component 201 acts. At the moment when the continuum particle 210 passes through the intersection point 212, the distance between the micro-surface component 202 and the continuum particle 210 becomes zero. Herein, in the case of using the calculation formula diverging when the distance between the continuum particle and the micro-surface component is zero, an extremely large force acts on the continuum particle 210 from the micro-surface component 202 at the moment when the continuum particle 210 passes through the intersection point 212. Therefore, in a case of using the formula diverging when the distance between the continuum particle and the micro-surface component is zero, the calculation of the repulsive force is failed under circumstances as illustrated in FIG. 7. Therefore, in order not to fail the calculation even in the case of FIG. 7, Formula (2) is configured not to diverge even when rₙᵢⱼ becomes zero. By doing so, the numerical calculation can stably proceed.

Subsequently, the repulsive force calculation unit 3 determines whether the calculation of the repulsive force has been completed with respect to all micro-surface components of the list (step S6). When the calculation of the repulsive force has not been completed with respect to all micro-surface components of the list (No in step S6), the process returns to step S5.

On the other hand, when the calculation of the repulsive force has been completed with respect to all micro-surface components of the list (Yes in step S6), the repulsive force calculation unit 3 identifies the nearest micro-surface component with respect to each continuum particle (step S7). The processing of identifying the nearest micro-surface component will be described below.

The repulsive force calculation unit 3 changes the repulsive force from the nearest micro-surface component with respect to the continuum particle i to the normalized repulsive force f_{nearest,ij}, such that the repulsive force diverges at the distance of zero (step S8). In the embodiment, the repulsive force expressed as Formula (3) is set as the repulsive force from the micro-surface component j, which is the nearest micro-surface component, with respect to the continuum particle i.

$${f}_{nearest , ij} = {n}_{j} \{ \begin{matrix}{f}_{0 , i} \frac{1 - q}{q} & - {f}_{ max} \vert {r}_{nij} \vert < {r}_{f max} \\ 0 & {r}_{f max} \leq \vert {r}_{nij} \vert\end{matrix} \qquad ( 3 )$$

In this manner, by setting the repulsive force from the nearest micro-surface component to diverge at the distance of zero, it is possible to avoid a situation that even a continuum particle having very large kinetic energy penetrates the fixed boundary.

The pressure calculation unit 4 calculates the pressure from the fixed boundary to the continuum particle by adding the repulsive force fij to the continuum particle i, which is expressed as Formula (2), and the repulsive force f_{nearest,ij} to the continuum particle i, which is expressed as Formula (3) (step S9).

The analysis unit 5 calculates the acceleration of the continuum particle i, which is caused by the pressure from the fixed boundary. Subsequently, the analysis unit 5 adds the acceleration of the continuum particle i, which is caused by the pressure from the fixed boundary, and the acceleration of the continuum particle i, which is calculated based on the physical model (step S10).

The analysis unit 5 determines whether the calculation of the acceleration has been completed with respect to all continuum particles at the time point (step S11). When there is the continuum particle whose acceleration has not been calculated (No in step S11), the process returns to step S3.

Subsequently, when the calculation of the acceleration has been completed with respect to all continuum particles at the time point (Yes in step S11), the analysis unit 5 performs time integration on the physical quantity of each continuum particle and micro-surface component by using a time derivative term containing the acceleration of each continuum particle, and obtains the motion of each continuum particle at the time point (step S12). Herein, the expression “obtains the motion of each continuum particle” means obtaining the central coordinates, velocity, influence radius, density, mass, deformation gradient tensor, material property, and temperature of each continuum particle.

The analysis unit 5 outputs the calculation result of the motion of the continuum particle at the time point when the motion has been obtained (step S13).

The analysis unit 5 determines whether the calculation of the motion of the continuum particle at all timings within the predetermined certain time has been completed (step S14). When the calculation of the motion of the continuum particle at all timings within the certain time has not been completed (No in step S14), the process returns to step S2. Subsequently, after progressing time, the repulsive force calculation unit 3, the pressure calculation unit 4, and the analysis unit 5 calculate the motion of the continuum particle at next timing.

On the other hand, when the calculation of the motion of the continuum particle at all timings within the certain time has been completed (Yes in step S14), the analysis unit 5 summarizes the motion of the continuum particle at each time point, and obtains the motion of the entire continuum particles (step S15). In this manner, a series of motion of the continuum within the certain time is obtained, and the continuum motion analysis apparatus ends the continuum motion analysis.

Next, the processing of identifying the nearest micro-surface component will be described in detail with reference to FIG. 8. The description herein is a detailed description about the processing of identifying the nearest micro-surface component with respect to each continuum particle by the repulsive force calculation unit 3 in step S7 of FIG. 2. FIG. 8 is a flowchart of the processing of identifying the nearest micro-surface component. Hereinafter, the identification of the nearest micro-surface component with respect to the continuum particle i will be described.

The repulsive force calculation unit 3 extracts the micro-surface component j satisfying the following condition in the created list of the micro-surface components intersected with the influence range of the continuum particle i (step S71). This condition is two conditions that the continuum particle i is located in the normal direction of the micro-surface component j, and also, when a vertical line is drawn down from the continuum particle i to the micro-surface component j, a contact point is present within the micro-surface component j. Specifically, the repulsive force calculation unit 3 determines whether the micro-surface component j with respect to the continuum particle i satisfies the relationship of rᵢⱼ·nⱼ<0. The symbol “·” represents the inner product. As illustrated in FIG. 3, when rᵢⱼ·nⱼ<0, it can be considered that the continuum particle i is located in the normal direction of the micro-surface component j. Furthermore, the repulsive force calculation unit 3 determines whether the continuum particle i and the micro-surface component j satisfy Rⱼ>|rₜᵢⱼ|. As illustrated in FIG. 4, when Rⱼ>|rₜᵢⱼ|, it can be considered that when a vertical line is drawn down from the continuum particle i to the micro-surface component j, a contact point is present within the micro-surface component j. The repulsive force calculation unit 3 extracts the micro-surface components j satisfying rᵢⱼ·nⱼ<0 and Rⱼ>|rₜᵢⱼ|.

Subsequently, the repulsive force calculation unit 3 determines that the micro-surface component nearest to the continuum particle i among the extracted micro-surface components j, that is, the micro-surface component j of which |rₙᵢⱼ| is smallest, is a virtual nearest micro-surface component (step S72).

Subsequently, the repulsive force calculation unit 3 determines whether there is the micro-surface component intersected with the virtual nearest micro-surface component, as if protruding in the direction of the continuum particle (step S73). The method of determining whether there is the micro-surface component intersected as if protruding in the direction of the continuum particle will be described below in detail.

Subsequently, when there is the micro-surface component intersected as if protruding in the direction of the continuum particle (Yes in step S73), the repulsive force calculation unit 3 excludes the micro-surface component set as the virtual nearest micro-surface component among the micro-surface components that are intended to specify the nearest micro-surface component (step S74). Subsequently, the process returns to step S72, and the repulsive force calculation unit 3 finds the micro-surface component nearest to the continuum particle again.

On the other hand, when there is no micro-surface component intersected as if protruding in the direction of the continuum particle (No in step S73), the repulsive force calculation unit 3 identifies the micro-surface component being the virtual nearest micro-surface component as the nearest micro-surface component (step S75).

In this manner, the repulsive force calculation unit 3 can identify the nearest micro-surface component with respect to each continuum particle in step S7 of FIG. 2.

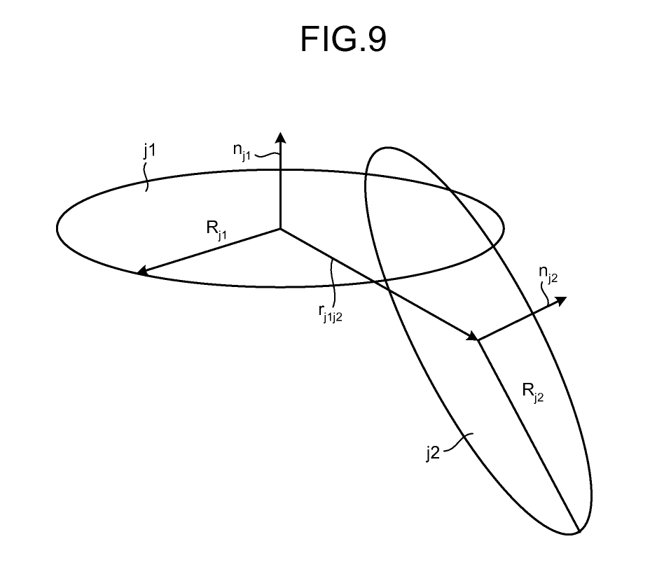

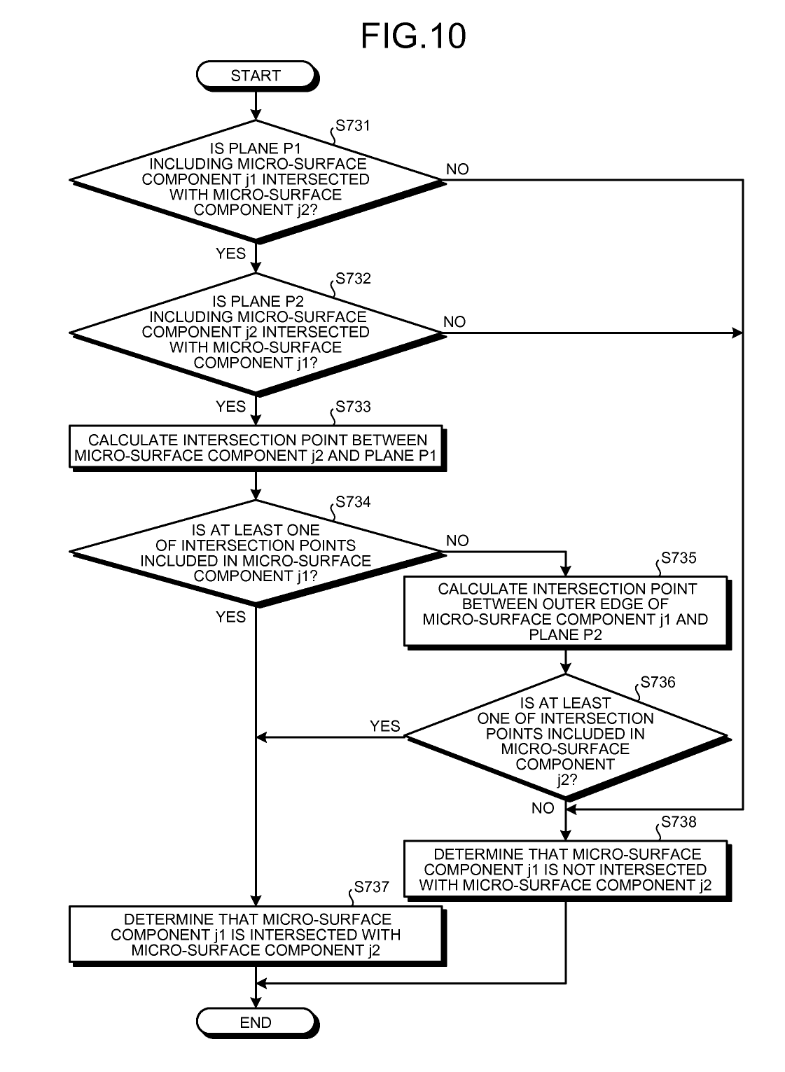

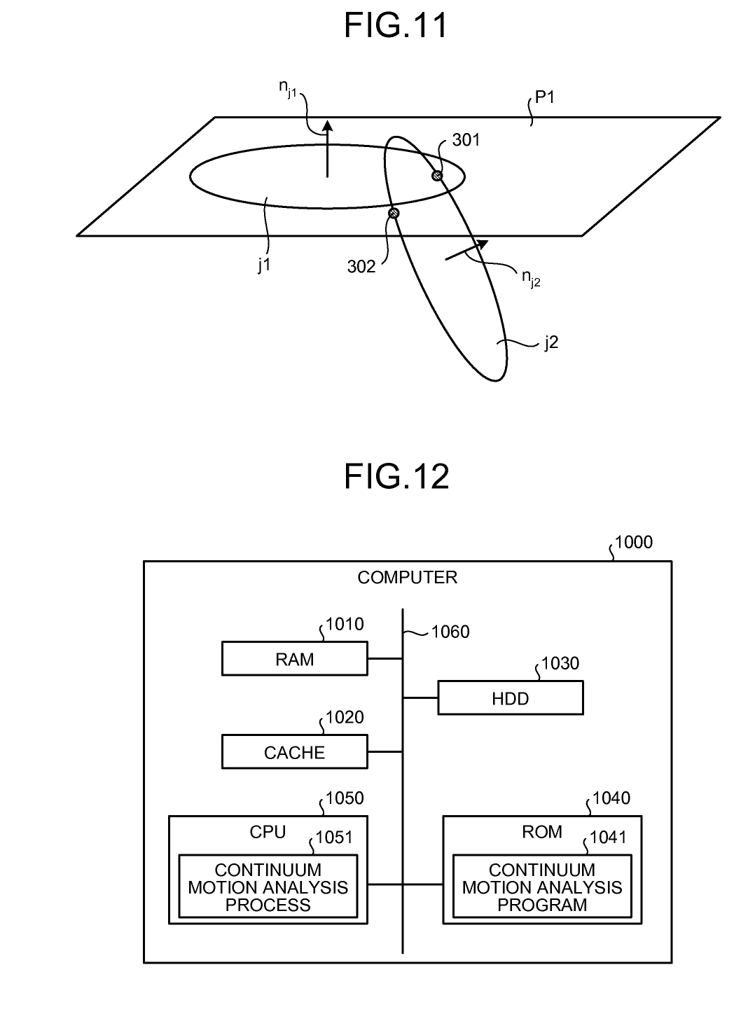

Herein, in a case where two micro-surface components are present, the method of determining whether the two micro-surfaces are intersected with each other as if protruding in the direction of the continuum particle will be described with reference to FIGS. 9, 10 and 11. This description is a detailed description about the processing of step S73 of FIG. 8. FIG. 9 is a diagram for describing the determination as to whether two micro-surface components are intersected with each other as if protruding in the direction of the continuum particle. Also, FIG. 10 is a flowchart of the processing of determining whether two micro-surface components are intersected with each other. Also, FIG. 11 is a diagram of a state in which the plane including the micro-surface component of one side is intersected with the micro-surface component of the other side.

First, the determination as to whether two micro-surface components are intersected with each other as if protruding in the direction of the continuum particle will be described with reference to FIG. 9. Herein, two micro-surface component numbers are described as j1 and j2. Two micro-surface components are represented as the micro-surface component j1 and the micro-surface component j2. The normal vector of the micro-surface component j1 is assumed as nⱼ₁, and the radius of the micro-surface component j1 is assumed as Rⱼ₁. Also, the normal vector of the micro-surface component j2 is assumed as nⱼ₂, and the radius of the micro-surface component j2 is assumed as Rⱼ₂. Furthermore, the relative position vector directed from the center of the micro-surface component j1 to the center of the micro-surface component j2 is assumed as rⱼ₁ⱼ₂.

When satisfying two formulas of rⱼ₁ⱼ₂·nⱼ₁<0 and −rⱼ₁ⱼ₂·nⱼ₂<0, it can be considered that the micro-surface component j1 and the micro-surface component j2 protrude in the direction of the continuum particle. Therefore, when the micro-surface component j1 is the virtual nearest micro-surface component, the repulsive force calculation unit extracts the micro-surface component j2 satisfying two formulas of rⱼ₁ⱼ₂·nⱼ₁<0 and −rⱼ₁ⱼ₂·nⱼ₂<0.

Next, the method of determining, by the repulsive force calculation unit 3, whether the micro-surface component j1 and the micro-surface component j2 are intersected with each other will be described with reference to FIGS. 10 and 11.

First, the repulsive force calculation unit 3 determines whether the plane P1 including the micro-surface component j1 is intersected with the micro-surface component j2 (step S731). Specifically, the repulsive force calculation unit 3 determines whether |rⱼ₁ⱼ₂·nⱼ₁|<Rⱼ₂ sin θ. When |rⱼ₁ⱼ₂·nⱼ₁|<Rⱼ₂ sin θ, the repulsive force calculation unit 3 determines that the plane P1 including the micro-surface component j1 is intersected with the micro-surface component j2. Herein, θ is an angle formed by two normal vectors nⱼ₁ and nⱼ₂, and is expressed as θ=arcos(nⱼ₁·nⱼ₂). When the plane P1 including the micro-surface component j1 is not intersected with the micro-surface component j2 (No in step S731), the repulsive force calculation unit 3 determines that the micro-surface component j1 and the micro-surface component j2 are not intersected with each other (step S738).

On the other hand, when the plane P1 including the micro-surface component j1 is intersected with the micro-surface component j2 (Yes in step S731), the repulsive force calculation unit 3 determines whether the plane P2 including the micro-surface component j2 is intersected with the micro-surface component j1 (step S732). When the plane P2 including the micro-surface component j2 is not intersected with the micro-surface component j1 (No in step S732), the repulsive force calculation unit 3 determines that the micro-surface component j1 and the micro-surface component j2 are not intersected with each other (step S738).

On the other hand, when the plane P2 including the micro-surface component j2 is intersected with the micro-surface component j1 (Yes in step S732), the repulsive force calculation unit 3 calculates the intersection point between the outer edge of the micro-surface component j2 and the plane P1 (step S733). Specifically, the repulsive force calculation unit 3 can calculate an intersection points 301 and 302 between the outer edge of the micro-surface component j2 and the plane P1 by solving simultaneous equations for the unknown vector r, as expressed in Formula (4) below.

$$\{ \begin{matrix}( r - {r}_{j 1} ) \cdot {n}_{j 1} = 0 \\ ( r - {r}_{j 2} ) \cdot {n}_{j 2} = 0 \\ {( r - {r}_{j 2} )}^{2} = {R}_{j 2}^{2}\end{matrix} \qquad ( 4 )$$

By solving the simultaneous equations of Formula (4), at most two intersection points are calculated. Therefore, the repulsive force calculation unit 3 determines whether at least one of the calculated intersection points 301 and 302 is included in the micro-surface component j1 (step S734). When at least one of the intersection points 301 and 302 is included in the micro-surface component j1 (Yes in step S734), the repulsive force calculation unit 3 determines that the micro-surface component j1 and the micro-surface component j2 are intersected with each other (step S737).

On the other hand, when none of the intersection points 301 and 302 is included in the micro-surface component j1 (No in step S734), the repulsive force calculation unit 3 calculates the intersection point between the outer edge of the micro-surface component j1 and the plane P2 (step S735). In this case, the repulsive force calculation unit 3 can calculate the intersection point by solving the simultaneous equations in which j1 and j2 of Formula (4) are replaced with each other.

Subsequently, the repulsive force calculation unit 3 determines whether at least one of the calculated intersection points is included in the micro-surface component j2 (step S736). When at least one of the intersection points is included in the micro-surface component j2 (Yes in step S736), the repulsive force calculation unit 3 determines that the micro-surface component j1 and the micro-surface component j2 are intersected with each other (step S737).

On the other hand, when none of the intersection points is included in the micro-surface component j2 (No in step S736), the repulsive force calculation unit 3 determines that the micro-surface component j1 and the micro-surface component j2 are not intersected with each other (step S738).

In this manner, the repulsive force calculation unit 3 can determine whether there is the micro-surface component intersected with the virtual nearest micro-surface component as if protruding in the direction of the continuum particle in step S73 of FIG. 8.

[Program]

Also, the variety of processing described in the above embodiments can be realized by causing a computer to execute a prepared program. Therefore, hereinafter, an example of a computer executing a continuum motion analysis program having a function of performing the processing of analyzing the motion of the continuum particle as illustrated in FIG. 2 will be described with reference to FIG. 12.

FIG. 12 is a diagram illustrating a computer that executes the continuum motion analysis program. As illustrated in FIG. 12, a computer 1000 includes a random access memory (RAM) 1010, a cache 1020, a hard disk drive (HDD) 1030, a read only memory (ROM) 1040, a central processing unit (CPU) 1050, and a bus 1060. The RAM 1010, the cache 1020, the HDD 1030, the ROM 1040, and the CPU 1050 are connected by the bus 1060.

The ROM 1040 previously stores a continuum motion analysis program 1041 that fulfills the function of analyzing the motion of the continuum particle as illustrated in FIG. 2.

The CPU 1050 reads and executes the continuum motion analysis program 1041. Therefore, as illustrated in FIG. 12, the continuum motion analysis program 1041 becomes a continuum motion analysis process 1051.

Also, the continuum motion analysis program 1041 does not necessarily have to be stored in the ROM 1040. For example, the continuum motion analysis program 1041 may also be stored in a “transportable physical medium”, such as a flexible disk (FD), a compact disk-read only memory (CD-ROM), a magneto-optical (MO) disk, a digital versatile disk (DVD), a magnetic optical disk, or an integrated circuit (IC) card, which is inserted into the computer 1000. Alternatively, the continuum motion analysis program 1041 may also be stored in a “fixed physical medium”, such as a hard disk drive (HDD), which is provided inside or outside the computer 1000. Furthermore, the continuum motion analysis program 1041 may also be stored in “another computer (or server)” connected to the computer 1000 through a public line, the Internet, a local area network (LAN), a wide area network (WAN), or the like. Then, the computer 1000 may read out each program from the above-described flexible disk or the like and execute the read program.

As described above, in the embodiment, the fixed boundary is represented by the micro-surface component, and the pressure applied from the fixed boundary to the continuum particle can be calculated by using the repulsive force directed to the normal direction from the micro-surface component with respect to each continuum particle. Since an appropriate micro-surface component can be selected, it is easy to handle a fixed boundary of a complex shape. Therefore, the analysis technology according to the embodiment can be applied to the fixed boundary of any shape. Also, the force applied to each continuum particle is calculated using the repulsive force of the normal direction from the micro-surface component with respect to the continuum particle. Therefore, only if the fixed boundary has a simple shape, the repulsive force acts on the continuum particles in the same direction. Hence, the repulsive force can be exactly calculated with a few micro-surface component. That is, the fixed boundary can be represented by a few micro-surface boundaries. Therefore, it is possible to reduce both of the memory capacity and the calculation time necessary for the numerical analysis. In the case where the same calculation resources are used, a larger size of numerical analysis can be performed as compared with the prior art.

Also, the embodiment performs the weighting that is proportional to the area of the intersection between each micro-surface component and the influence range of the continuum particle. Therefore, in a case where the sizes of the micro-surface components are different, the repulsive force is continuously changed even though the continuum particle moves near the boundary between the micro-surface components. Therefore, the influence of the fixed boundary on the continuum particle can be represented more realistically.

Also, when the boundary surface is represented as a set of microdisks, some surface components are inevitably intersected with other surface components in order to cover the surface protruding in the direction of the continuum particle without gaps. In this case, the repulsive force may be discontinuously changed at the edge of the boundary in the surface component intersected as if protruding in the direction of the continuum particle. At that time, since the repulsive force may have a very large value, overflow occurs in the numerical analysis using an explicit time integration method. Therefore, the prior art has a problem that the calculation cannot be actually progressed any more.

In this regard, in the embodiment, among the repulsive forces received by the continuum particle, the component diverging to the infinity is received from only the nearest micro-surface component. Therefore, the opportunity to receive a very large repulsive force near the edge of the boundary in the surface component intersected as if protruding in the direction of the continuum particle can be reduced, and the numerical calculation can be stably progressed even in a case of using the explicit solving method.

Furthermore, in the prior art, when one boundary condition representing the action on the continuum particle from the fixed boundary is set by individually preparing a plurality of boundaries represented by a polygon and combining them, it is necessary to appropriately set the joint condition of the plurality of boundaries. In contrast, in the embodiment, since it is unnecessary to calculate the relationship of the boundary surface components, it is unnecessary to set the joint condition. Therefore, the time and effort to set a complex boundary condition can be reduced.

As described above, the continuum motion analysis program, the continuum motion analysis method, and the continuum motion analysis apparatus according to the embodiments are useful for the numerical calculation using the particle method. In particular, regarding the fluid analysis of river or sea water, the use of the continuum motion analysis program, the continuum motion analysis method, and the continuum motion analysis apparatus according to the embodiments can be helpful in planning disaster prevention. Also, a casting process can be analysis using the continuum motion analysis program, the continuum motion analysis method, and the continuum motion analysis apparatus according to the embodiments, contributing to product design. Also, regarding an elastic body, the shape or the like of sealing gel can be appropriately determined during product design by using the continuum motion analysis program, the continuum motion analysis method, and the continuum motion analysis apparatus according to the embodiments, contributing to product design.

According to one aspect of the continuum motion analysis method, and the continuum motion analysis apparatus discussed therein, the case that is difficult to be applied can be reduced, and the effect that reduces the memory capacity and calculation time which is used for performing analysis is obtained.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention have been described in detail, it should be understood that the various changes, substitutions, and alterations could be made hereto without departing from the spirit and scope of the invention.

What is claimed is:

1. A computer-readable recording medium having stored therein a continuum motion analysis program causing a computer to execute a process, the process comprising:
receiving input of data including information of an influence range representing each of continuum particles when the continuum is represented as a particle, and data representing each micro-surface component, which includes information of a normal direction when a fixed boundary is represented as a set of minute regions;
first calculating a repulsive force of the normal direction of each of the micro-surface components, which acts on the continuum particle from each of the micro-surface components intersected with the influence range of the continuum particle;
second calculating a force from the fixed boundary acting on each of the continuum particles by adding the repulsive forces acting on each of the continuum particles from each of the micro-surface components; and
analyzing the motion of the continuum, based on the force acting on each of the continuums from the fixed boundary.

2. The computer-readable recording medium according to claim 1, wherein when a distance between the continuum particle and the micro-surface component included in the influence range of the continuum particle is equal to or greater than at least a predetermined distance, the first calculating includes calculating a force from the micro-surface component, which is in inverse proportion to the distance, and calculates the repulsive force acting on the continuum particle from the micro-surface component by weighting the calculated force from the micro-surface component according to an area of an intersection between the influence range of the continuum particle and the micro-surface component included in the influence range.

3. The computer-readable recording medium according to claim 1, wherein the first calculating includes calculating the repulsive force from the micro-surface component such that the repulsive force from the micro-surface component diverges when the distance between the continuum particle and at least one micro-surface component among the micro-surface components intersected with the influence range of the continuum particle being the subject of the repulsive force becomes zero.

4. The computer-readable recording medium according to claim 3, wherein the first calculating includes:
first determining the micro-surface component, which is intersected with the influence range of the continuum particle being the subject of the repulsive force, as a micro-surface component set;
second determining a micro-surface component, which is nearest to a continuum particle among the micro-surface component set, as a virtual nearest micro-surface component, wherein the continuum particle being the subject of the repulsive force is located in a normal direction thereof;
excluding the micro-surface component, which is determined as the virtual nearest micro-surface component, from the micro-surface component set when the virtual nearest micro-surface component is intersected with another micro-surface component, which is included in the micro-surface component set, such that an intersecting part protrudes in the direction of the continuum particle;
repeating the second determining and the excluding to obtain a virtual nearest micro-surface component, which is not intersected with another micro-surface component, which is included in the micro-surface component set, as if protruding in the direction of the continuum particle, and specifying the obtained virtual nearest micro-surface component as the nearest micro-surface component; and
calculating the repulsive force from the nearest micro-surface component, such that the repulsive force from the nearest micro-surface component diverges, when a distance between the continuum particle and the nearest micro-surface component is zero.

5. The computer-readable recording medium according to claim 1, wherein the data representing the continuum particle includes central coordinates, a velocity, an influence radius, a density, a mass, a deformation gradient tensor, a material property, and a temperature.

6. The computer-readable recording medium according to claim 1, wherein when the micro-surface component is represented by a disk, the data representing the micro-surface component includes central coordinates, a normal vector, and an area.

7. The computer-readable recording medium according to claim 1, wherein when the micro-surface component is represented by a polygon, the data representing the micro-surface component is position coordinates of a vertex of the polygon.

8. The computer-readable recording medium according to claim 1, wherein the analyzing includes calculating acceleration of each of the continuum particles, based on the force acting on each of the continuum particles from the fixed boundary at a specific time point, calculates the motion of the continuum at the specific time point by integrating the calculated acceleration with time, and analyzes the motion of the continuum by summarizing the motion of the continuum at each time point along time series.

9. A continuum motion analysis method comprising:
receiving, using a processor, input of data including information of an influence range representing each continuum particle when the continuum is represented as a particle, and data representing each micro-surface component, which includes information of a normal direction when a fixed boundary is represented as a set of minute regions;
calculating, using the processor, a repulsive force of the normal direction of each of the micro-surface component, which acts on the continuum from each of the micro-surface components intersected with the influence range of the continuum particle;
calculating, using the processor, a force from the fixed boundary acting on each of the continuum particles by adding the repulsive forces from each of the micro-surface components; and
analyzing, using the processor, the motion of the continuum, based on the force acting on each of the continuum particles from the fixed boundary.

10. A continuum motion analysis apparatus comprising:
a processor; and
a storage unit that receives input of data including information of an influence range representing each continuum particle when the continuum is represented as a particle, and data representing each micro-surface component, which includes information of a normal direction when a fixed boundary is represented as a set of minute regions, and stores each data,
wherein the processor executes a process comprising:
calculating a repulsive force of the normal direction of each of the micro-surface component, which acts on the continuum particle from each of the micro-surface components intersected with the influence range of the continuum particle;
calculating a pressure from the fixed boundary acting on each of the continuum particles by adding the repulsive forces from each of the micro-surface components; and
analyzing the motion of the continuum, based on the force acting on each of the continuum particles from the fixed boundary.
